(19) United States
(12) Patent Application Publication
(10) Pub. No.: US 2013/0132120 A1
(43) Pub. Date: May 23, 2013

(54) MEDICAL RECORD CARDS AND STORAGE SYSTEMS

(71) Applicant: Geoffrey Flagstad, Versailles, MO (US)

(72) Inventor: Geoffrey Flagstad, Versailles, MO (US)

(21) Appl. No.: 13/747,099

(22) Filed: Jan. 22, 2013

Related U.S. Application Data
(63) Continuation of application No. 10/679,749, filed on Oct. 6, 2003.

(51) Int. Cl. G06F 19/00

(52) U.S. Cl. CPC G06F 19/322
USPC 705/3

(57) ABSTRACT

A method and apparatus for obtaining and storing medical records of a patient from an entity covered by HIPAA in a form allowing quick disclosure of the patient's medical history to a third party without restriction or delay by HIPAA. The method comprises inducing a patient to obtain possession of his or her own medical record from a covered entity; acquiring the medical record from the patient in a storage format; and storing the medical record in a memory in a form from which it can be reproduced in the storage format as received from the patient. The memory used to store the medical record can be a hard drive in an Internet server, or be a portable medium, such as a CD or DVD, and can be small enough to fit in the patient's wallet, purse or pocket.

### CROSS-REFERENCE TO RELATED APPLICATIONS

This is a continuation of Ser. No. 10/679,749, filed Oct. 6, 2003, now pending. That entire application is incorporated by reference here.

### BACKGROUND OF THE INVENTION

The proposed classification of this specification is U.S. Class: 705/3, International Class: G06F 017/60.

The present invention relates generally to a method and apparatus for obtaining and storing medical records of a patient from an entity covered by the Health Insurance Portability and Accountability Act of 1996 (“HIPAA”) in a form allowing quick disclosure of the patient's medical history to a third party without restriction or delay by HIPAA.

When providing health care, a physician interviews the patient to obtain a medical history, examines the patient, and conducts or orders physical and laboratory studies. The treatment prescribed by the physician will be determined from the interview and the results of examination and tests. These tests can be costly. With a proper medical history some tests may not be necessary. A physician's full and accurate knowledge of a patient's medical history including information such as current medications, drug allergies, past medical test results, etc. will permit the physician to diagnose the patient more accurately, more quickly and more efficiently.

In the current medical world, however, a patient in most cases never sees his or her own medical records. The patient may not remember accurately all the details of his or her treatments, nor be able to obtain records from their source. Old records are lost, particularly when hospitals merge, physicians retire, new physicians are consulted, time passes, or the recordkeeping system changes (as when changing from paper records to electronic records, at which time the information on the paper records may not be transferred). Current records are difficult to obtain. And it takes time for the patient to recall where relevant medical records are kept, to retrieve them, and for medical personnel to look through them for relevant information.

In an emergency, for example if the patient has suffered trauma or is unconscious, the patient may be unable to provide a medical history when it is urgently needed. Emergency medical care is the most expensive component of most corporate healthcare benefit programs. Statistics show that forty percent of all hospital admissions start with an emergency room admission and usually result in long term care. There are 110 million plus emergency room visits each year in the United States. There are over 60 million hospital admissions in either federally regulated hospitals or community hospitals. Medical expenses are approximately 14% of the Gross National Product (GNP) of the United States. On average, proper medical histories if available on demand in clinics or hospitals for patient care would reduce medical testing and save $250 to $500 per hospital visit. For example, with a patient's complete medical history, anomalies that are normal to the patient but abnormal on diagnosis would not require duplication of tests. Elimination of unnecessary testing would also reduce emergency admissions.

For these and other reasons, health care providers have invested considerable effort in the technologies related to the computerization, storing and sharing, typically by fax or computer communications networks, of patients' medical records and information. A medical release titled “Emergency Department Technology” and dated Mar. 17, 2002, a publication of the American College of Emergency Physicians (“ACEP”) discusses standards for the future of technology in emergency medicine. The first objective standard stated in the release is: “All medical personnel involved in caring for a patient will be working from the same electronic record.”

However, electronic transmission of a patient's medical information is subject to a series of federal laws and regulations, such as HIPAA. Under HIPAA, generally, physicians, hospitals, health care clearinghouses (“HCCs”), or other health care entities cannot release medical information or records about an individual to third parties without written permission by that individual. As required by HIPAA of 1996, the U.S. Department of Health and Human Services (“HHS”) issued Standards for Privacy of Individually Identifiable Health Information (“Privacy Rule”) very recently. See HIPAA .sctn. 264, 42 U.S.C. .sctn. 1320d-2 note (2003). The Privacy Rule establishes a set of standards for protecting certain types of health information and applies to “covered entities” and “business associates” of a covered entity, as defined in HIPAA and its regulations. It restricts the use and disclosure of “individually identifiable health information” that is transmitted or maintained, in any medium, by a covered entity or its business associates.

The Privacy Rule was intended to protect the individual from reckless dissemination of personal medical information. It mandates certain behavior and procedures that must be followed strictly when handling, transferring, and processing a patient's medical information. As a result, all medical providers and staff must demonstrate HIPAA compliance or face severe sanctions including loss of reimbursement, loss of billing privileges, and even severe fines.

HIPAA has caused many impediments to communication between healthcare providers and the transfer of medical information, particularly between separate medical entities. Fears of litigation have caused the medical community to test for a wide series of disease states, instead of finding out what testing has been done elsewhere. There is also reluctance to share medical information lest one run afoul of these potentially-costly policies. Even those willing to share medical information may not be able to do so quickly, or outside of normal business hours, or may be reluctant to undergo the effort to determine and document that the records may properly be transferred to the requester. Therefore, there is a need among the medical community for a way to acquire medical records of a patient from a covered entity, store them in a form meeting the ACEP standards, and quickly disclose the medical information to a third party without restriction by HIPAA.

This need is not addressed and solved by prior medical information storage and retrieval systems. Rosen, et. al. (U.S. Pat. No. 6,073,106, the “Rosen patent”) relates to methods of managing personal or medical information and of controlling access to it by Internet communications or by phone/fax/mail, and more particularly to those methods in which a security measure may be overruled and access to a portion of the personal information may be disclosed under specified circumstances. However, the Rosen patent does not disclose how to acquire, transmit and store the medical record to avoid the information service provider from being a “covered entity” (or a “business associate” of a “covered entity”) under HIPAA. Even more so, some other medical data storage and retrieval information systems, such as those of U.S. Pat. Nos. 5,455,082, 5,327,341 and 4,315,309 which are discussed in the Rosen patent, have been directed to the needs of the health care provider or health plan, and developed without HIPAA in mind. These systems are likely to be covered by the Privacy Rule.

Known techniques to provide medical information to a physician include emergency medical bracelets, printed information cards, “smart cards,” and other products. These techniques all have important drawbacks. For example, only a limited amount of information can be stored as printed text on a medical information bracelet or card, even if the information is reduced to microfilm (in which case it cannot be read without a special reader). A magnetic strip or a “smart card” can store more information, but the health care provider must have access to a specially-designed smart card reader. This requires the entire medical establishment to invest in a particular technology. Furthermore, a person's medical file is a constantly-changing and fluid record in which important information may (and will) change overnight. Acting upon outdated information can be disastrous. However, an individual cannot quickly update his or her medical information stored on a smart card by him- or herself.

Berman (U.S. Pat. No. 6,523,116 B1) relates generally to a method and apparatus for personal information data storage and retrieval. More specifically, the Berman patent is directed to the use of a public key provided on one's business cards for use with a database operated by targeted recipients of such cards. The person's public key is published on business cards in legible or machine readable format. Even though this database system could store medical information of a person, the database system is developed with the targeted recipients of such business cards in mind and is not patient oriented. To use the system, a targeted recipient must have subscribed to the system and have had its own public key and private key. The Berman patent also does not explain how to put medical information on the system without requiring HIPAA compliance to give targeted receipts of the business cards Internet access to a database in the system. Furthermore, the Berman system requires the user to distribute the business cards recorded with his or her public key to the targeted recipients, so a recipient can use its own private key and the person's public key to get access to the person's information.

There are other medical data storage and retrieval information systems that offer online medical record services. Some of them, such as www.medicalogic.com, are designed primarily for use by healthcare organizations and providers and are updated as a physician enters new information on a patient's record. These services are subject to HIPAA regulations. Another requirement for these services is that the user must be part of a medical system that employs this service. This poses a concern for those in need of their medical records when traveling or living in an area not currently using the system. Other medical record storage sites, such as www.medrecordsweb.com and www.vitallink-canada.com-, require that the data either be entered by the subscribers' physicians or transferred from medical facilities to be input by the web site's staff. These transfers of personal medical information are subject to HIPAA regulations and will impose a great deal of extra paperwork and potential liability to those handling, processing, and entering the information. There will be a time delay in the data entry also, during which time medical conditions may develop or change. If there are errors in the information provided or data entry then these, too, will require time to change.

There is a strong need in the medical community for a medical record that can be update, easily and instantly, which is exempt from HIPAA regulations, and from which important and relevant information of the patient can be accessed and conveyed quickly.

### SUMMARY OF THE INVENTION

The present invention provides a method for a service provider that is not the patient or a covered entity to obtain a medical record of a patient from a HIPAA “covered entity,” for example a physician, hospital, or insurance company. The record is obtained in a form allowing it to be disclosed to a third party without restriction by HIPAA. The method includes several steps.

The patient obtains the medical record from a covered entity in a first format and converts the received medical record to a converted medical record in a storage format that is not a medical record from a covered entity. Converting includes summarizing, abstracting, retyping, redacting, supplementing, or organizing the medical record. The medical record is converted without the service provider modifying the information or its format in the received or converted medical record. The storage format is different from the first format.

The service provider, which is not the patient or a covered entity, receives the converted medical record from the patient in the storage format. The service provider stores the converted medical record in a form from which the converted medical record can be reproduced in the storage format. The service provider also undertakes to transmit the converted medical record to a third party in the storage format as received from the patient under defined conditions. The service provider transmits the converted medical record to a third party in the storage format as received from the patient when the defined conditions occur.

Another aspect of the invention is a method for a patient to convert a medical record of the patient from a covered entity to a form allowing quick disclosure of the medical record to a third party without restriction by the Health Insurance Portability and Accountability Act of 1996. In this method, the patient obtains possession of the medical record from a covered entity and converts the medical record into a storage format. Converting includes summarizing, abstracting, retyping, redacting, supplementing, or organizing the medical record, without any service provider modifying the information or its format in the medical record. The storage format is different from the first format. The patient stores the converted medical record in a memory in the storage format. The memory is accessible to the service provider, and the converted memory is not under restriction by the Health Insurance Portability and Accountability Act of 1996.

Yet another aspect of the invention is a medical and personal information system for obtaining and storing a medical record of a patient from a covered entity in a form allowing quick disclosure of the medical record to a third party without restriction by the Health Insurance Portability and Accountability Act of 1996.

The system includes a communication interface provided at least in part by a service provider that is not the patient or a covered entity. The interface is adapted to enable the patient to obtain possession of the medical record of the patient from a covered entity in a first format. The interface is further adapted to enable the patient to convert the obtained medical record from the first format to a converted medical record in a storage format that is different from the first format, without the service provider modifying the information or its format in the converted medical record.

The system includes a data storage device provided at least in part by a service provider. The data storage device includes a memory adapted for storing the converted medical record in the storage format and reproducing the converted medical record in the storage format. The storage device is configured to store the converted medical record in the storage format.

### BRIEF DESCRIPTION OF SEVERAL VIEWS OF THE DRAWINGS

FIG. 1 shows the system components of the invention and the information flow among the system components according to an embodiment of the present invention.

FIGS. 2 and 3 show a hierarchical storage system according to an embodiment of the present invention.

### DETAILED DESCRIPTION OF THE INVENTION

As used herein, “patient” means the subject of the information in question, and a “patient” does not need to be a person currently receiving or seeking medical care. A “service provider” is a person or entity carrying out or assisting a patient or a third party to carry out the present invention, where the service provided is one or more steps of the invention, or a software or hardware system that the patient or a third party can use to carry out one or more steps of the invention.

The present invention is unique in that it emphasizes immediacy of information retrieval by a patient or the patient's representatives and it emphasizes the absolute patient control of the information recording process. The present invention involves constructing a file system from the ground up (the patient) as opposed to a top down (physicians, hospitals, pharmacies, or other health care providers) approach. These unique characteristics of the present invention will exempt an Internet medical storage system based on the present invention from HIPAA, because such a system is neither a covered entity nor a business associate of a covered entity as defined by HIPAA and other regulations.

A covered entity is a “health plan,” “health care clearinghouse,” or “health care provider who transmits any health information in electronic form in connection with a transaction.” 45 C.F.R. .sctn. 160.103; see 42 U.S.C. .sctn. 1320d-1(a). A health plan is “an individual or group plan that provides, or pays the cost of, medical care.” 45 C.F.R. .sctn. 160.103; see also 42 U.S.C. .sctn. 1320d(5) (defining “health plan”). A health care clearinghouse (“HCC”) is a “public or private entity” that either “[p]rocesses or facilitates the processing of health information received from another entity in a nonstandard format or containing nonstandard data content into standard data elements or a standard transaction” or “[r]eceives a standard transaction from another entity and processes or facilitates the processing of health information into nonstandard format or nonstandard data content for the receiving entity.” 45 C.F.R. .sctn. 160.103; see also 42 U.S.C. .sctn. 1320d(2) (defining “health care clearinghouse”). A health care provider is a “provider of medical or health services,” including any “person or organization [that] furnishes, bills or is paid for health care in the normal course of business.” 45 C.F.R. .sctn. 160.103; see also 42 U.S.C. .sctn. 1320d(3) (defining “health care provider”). To be a business associate, the person performing the function or activity must be either doing so “on behalf of” a covered entity or providing a service “for” the covered entity that has provided the person with protected information. 45 C.F.R. .sctn. 160.103; see Standards, 65 Fed. Reg. at 82476.

A medical file storage system is not necessarily a health plan nor a health provider. It might however, be a health care clearinghouse (“HCC”) if it processes or facilitates the processing of health information received from another covered entity as defined by HIPAA and the regulations. Although neither the statute nor the regulations more precisely define “processing,” the use of the term in the statute, regulations, and the Privacy Rule indicates that unless an entity performs the processing function for another entity, it is not an HCC; entities that provide mechanisms to convey information (for example, Internet Service Providers and telephone companies) are not HCCs unless they perform the requisite processing function; and processing encompasses translation or conversion of medical records to or from a standard data format. In other words, to be an HCC, an entity must translate or facilitate the translation of incoming health information from a nonstandard format into a standard format for the covered entity it receives the data from, or it must translate or facilitate the translation of standard health information into a nonstandard format for the covered entity the data is being sent to. This interpretation is reinforced by the ordinary meaning of “process,” which is “a series of actions, changes, or functions bringing about a result.” The American Heritage Dictionary of the English Language (4th ed. 2000).

Furthermore, in general, an individual has a “right of access” to obtain a copy of protected health information regarding that individual. 45 C.F.R. .sctn. 164.524(a). A covered entity is both permitted and required to disclose protected health information to an individual or as provided by an authorization from the individual. 45 C.F.R. .sctn. 164.502(a)(1)(i), (iv). The regulations specifically point out that information disclosed with proper authorization can be re-disclosed by the recipient and is no longer restricted.

C.F.R. .sctn. 164.508(c)(2)(iii). In addition, in responding to comments on the proposed regulations, HHS has stated that after protected information has left a covered entity (or a business associate of a covered entity), HHS no longer has jurisdiction to protect the information. See Standards for Privacy of Individually Identifiable Health Information, 65 Fed. Reg. 82462, 82567 and 82631 (Dec. 28, 2000).

In accordance with an embodiment of the invention, the medical information of a patient stored in a medical file storage system is provided by the patient, and is stored as the patient provides without any change or alteration to its content or format. In other words, a medical file storage system based on the present invention copies, stores, retrieves, and delivers medical information in the storage format as received from the patient, who obtained his or her own medical information from a covered entity. Such a medical file storage system is not a HCC because it does not process or faciliate the processing of health information received from a covered entity; it only receives and stores medical information of a patient that is provided by the patient himself or herself; and the patient still owns and has full control of the information stored in such a system. A medical file storage system based on the present invention is not a business associate of a covered entity because it neither acts “on behalf of” a covered entity nor provides a service “for” the covered entity that has provided the Internet medical storage system with protected information.

In one embodiment of the present invention, the present method is conducted by an Internet medical storage service provider. Communications between the patient, the service provider and a third party medical information requester (hereinafter “the third party”) can be conducted by various means including online interactive communications between the patient's or the third party's computer and the service provider's Internet server and website (for example www.medlifecard.com; or www.mlcnet.net) by the Internet.

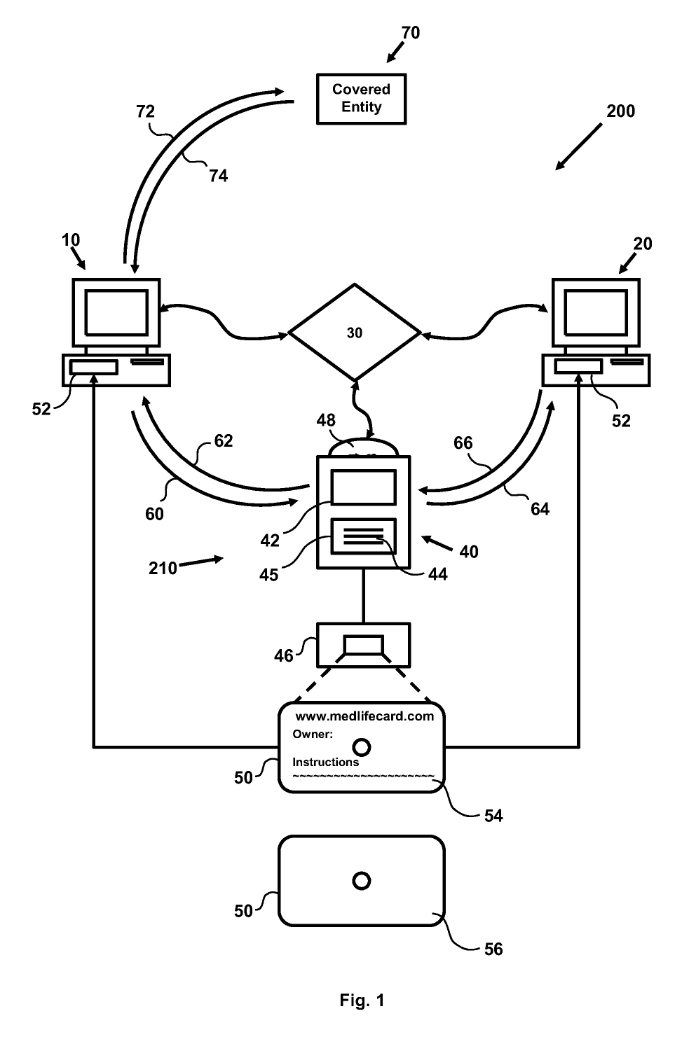

Referring to FIG. 1, in accordance with an embodiment of the present invention, a first personal computer 10 and a second computer 20 (or laptop or personal digital assistant, for example) include hardware and software (not shown) for connection to the Internet 30 or another computer communications network, which optionally may be publicly accessible. For example, the computers 10 and 20 may connect to the Internet 30 by modems, or may be nodes in a local area network (“LAN”) that has access to the Internet 30. The computer 10 is located in a place (for example the patient's home) so that the patient (not shown) can have access to and use it, and the computer 20 is located in a place (for example an emergency room) where a third party (for example an emergency room physician or attendant) can have access to and use it conveniently. The computer 20 might also be another computer the patient can personally use. The Internet server 40 may be located on the premises of an Internet medical storage service provider, and is connected to the Internet 30 to provide medical data storage services.

Referring still to FIG. 1, in one embodiment the Internet server 40 includes at least one data processor 42, a data storage medium 44 (for example the magnetic disks of a hard drive) of a data storage device 45 (for example the complete hard drive assembly), and optionally another data storage device 46, which may be a CD burner or other device which stores data on a CD 50 or other portable memory. Whatever internal configuation the Internet server 40 has, there is at least one communication link to the Internet 30 which permits access by authorized persons, such as medical personnel authorized by the patient or having access to the CD 50. The Internet server 40 provides access to its databases by interactive communications made over the Internet 30 on the website 48 of the Internet server 40.

The CD 50 or other portable memory in accordance with one embodiment of the present invention optionally can be specially shaped to fit in a wallet, or purse or pocket (not shown), and if adapted for wallet storage it can be slightly wider than a conventional wallet card, with indicia near its top, so it will project from a wallet pocket to display the indicia. The displayed indicia can indicate that the CD is a medical record so a medical person treating the patient when the patient is unconscious can readily find and use the information on the CD. The computer 10 or the Internet server 40 can be used to burn in part or all of the patient's medical file on the CD 50, which can be read by the CD-ROM drives 52 of the computers 10 and 20. The CD 50, as a memory, is also part of the data storage device 45 in this embodiment. As will be evident to those skilled in the art, the apparatus used to convert medical records to electronic form, produce the CD 50, and communicate by the Internet 30 need not be the same apparatus, or be in the same vicinity, or be operated by the same person or entity, providing the respective functions of any required apparatus are carried out in some manner.

In accordance with an embodiment of the invention, before the patient requires access to medical information, the patient is induced to register and open an account with the service provider to establish log-on information such as an account number, a user I.D., or a password, which the patient can use to log on to the service provider's Internet server 40 through its website 48. An account can be established, for example, by Internet communications or by phone/fax/mail communications. With the account log-on information, the patient can then log onto his or her account with the Internet server 40 using the computer 10, and once in his or her account, the patient can change his or her log-on information as he or she wants.

Referring still to FIG. 1, the transactions or online interactive communications between the patient and the service provider needed to carry out the present method are represented by the data flows 60 and 62 (which may either be via the Internet 30 or independent of the Internet, as by mailing records). The series of transactions or online interactive communications needed between the service provider and the third party medical information requester to carry out the present method are represented by the data flows 64 and 66 (which may either be via the Internet 30 or independent of the Internet, as by a patient carrying a CD 50 or other data storage medium made by, or with data sent from, the service provider and bringing the CD to an operator of the third-party computer 20); and the series of transactions or communications between the patient and a covered entity 70 (for example a hospital treated the patient before) who provides the medical record to the patient are represented by the data flow 72 and 74 (which may either be via the Internet 30 or independent of the Internet, as by mailing records). While transactions or communications by computers by the Internet 30 are preferred in some instances, transactions or communications by fax/phone/mail or other physical or electronic forms of delivery are also contemplated.

The Internet server 40 can be used to induce the patient to obtain his or her medical record from the covered entity 70. If the medical record is not in an storage format, the Internet server 40 can be used to induce the patient to convert the medical record to a storage format. Such a storage format may be a format that meets the ACEP standards. As an example, the patient may be induced to summarize, abstract, retype, redact, supplement, convert from paper to electronic form or vice versa, or otherwise modify from its original form a medical record obtained. The patient can easily convert the medical record using simple templates provided by the Internet server 40 directly on the website 48, or using templates that are downloaded to the computer 10 from the Internet server 40 or installed in the computer 10 with software offered by the service provider.

The medical record that the patient is induced to obtain may contain information such as immunizations received, physical examination results, past illnesses, personal histories, allergies, prescription drug usage, surgical and hospitalization history, medical histories of parents, grandparents, or siblings, laboratory or clinical test results, contact information for the medical personnel who have treated the patient, and so on. It may also include important documents or electronic records such as recent EKGs, magnetic resonance imaging studies (MRIs), X-rays, etc.

According to an embodiment, the Internet server 40, by its data processor 42, acquires the medical record in a storage format and then stores it in the storage medium 44 in a form from which it can be reproduced in the storage format. The medical record can be uploaded to the Internet server 40 directly by the Internet 30 as an electronic document. However, if a medical record is a paper document that needs to be scanned or otherwise copied to produce an electronic document, and the patient cannot prepare the electronic document, it can be mailed or faxed to the service provider or a third party, who can scan it into the Internet server 40 without changing its format or contents.

Optionally at least the most pertinent part of the medical record for emergency treatment is also stored on the CD 50. Referring to FIG. 1, in accordance with an embodiment of the present invention, basic information of the service provider (for example its name and website), of the patient (for example his or her name, account number, user ID, or password for emergency access to medical records), and instructions for use can be printed on a label 54 attached to the CD 50, and the patient's medical file can be burned onto one or more surfaces such as 56 of the CD 50.

If the patient's medical file is stored in both the storage medium 44 of the Internet server 40 and the CD 50, which are both memories: the CD 50 is a back-up to the Internet server 40 and the Internet server 40 is a back-up to the CD 50. The CD 50 may be produced in multiple copies for multiple uses, and the patient can carry a copy of the CD 50 in his or her wallet, purse or pocket, on a lanyard, give them to relatives or neighbors, keep them in an automobile, or otherwise make them available in an emergency.

However, Internet server 40 does not need to be involved in carrying out the present invention. In an alternate embodiment, for example, the service provider can offer a home software package for a patient or the patient's family. The home software package includes the system software for a home health file storage system and, optionally, a number of CDs 50 or other portable media. The home health file storage system can optionally be Internet interactive with the Internet medical storage system described above, but it can also be independent. Following instructions provided by the service provider, the patient installs the system software into the computer 10. The service provider can then induce the patient, through the system software and/or other instructions provided with the system software, to obtain his or her medical record from the covered entity 70, to input the medical record in a storage format into the computer 10, and to store it in a storage medium, such as the hard disk (not shown) of computer 10, CD 50 or other storage media (e.g., a smart card), in a form from which it can be reproduced in the storage format. In order to store the medical record in CD 50, a CD-burner is required, which can be the same device as the CD-ROM drive 52 if it is both a CD reader and rewriter.

Even though the CD 50 is specially shaped and is smaller than a regular CD, it can be universally used in most computers'CD or DVD readers, such as the CD-ROM drives 52 of the computers 10 and 20. The patient, his or her assignee or a third party authorized by him (for example a physician seeing the patient) can easily access, retrieve, or reproduce the medical record stored in the CD 50 or the Internet server 40 using the computer 10 or 20 and the information printed or stored on the CD 50.

In an embodiment, the service provider can obtain the agreement of the patient to allow transmission of the medical record to a health care provider, a relative, or another third party under defined conditions. This agreement may be obtained at the time the medical record is needed, but advantageously this agreement can be obtained in advance of treatment at the patient's convenience, before a defined condition arises necessitating immediate access to the record. Such defined conditions may include when the patient is in an emergency or unconscious condition, when the CD 50 is presented to health care provider, etc. By obtaining the agreement in advance, the patient can search for, obtain, and organize the records thoroughly and accurately, select what information to make available, and/or transmit the information in a suitable format to the service provider so it will be available and arranged in good order in an emergency.

For example, when the patient is away from home and is taken to an emergency room while unconscious for emergency care, the unique CD 50 in the patient's wallet, or pocket, or purse, can be designed to be easily seen so it will be found by a health care worker or other person searching for emergency medical information. Referring again to FIG. 1, the emergency attendant (not shown) can either use the CD-ROM drive 52 of the computer 20 to read the patient's medical file stored in the CD 50, or use the log-on information provided on the CD 50 or alternately a printed medical emergency card containing access information (not shown) to log onto the Internet 30 for access to the patient's medical file stored in the Internet server 40 (if it is available). Under this condition, in accordance with one embodiment of the present invention, the entity maintaining the Internet server 40 can be allowed by the agreement to immediately transmit the patient's medical record to the emergency attendant's computer 20 by the Internet 30 so the emergency attendant can quickly understand the patient's medical history or is immediately alerted to special conditions.

The present method may further comprise the step of inducing the patient to update the medical record stored in the memory, i.e. the storage medium. New information is easily updated by the patient by logging onto the Internet server 40 or entering the home health file storage system installed in the computer 10. The patient can update his or her records directly online, or can update the information with the template downloaded to or installed in the computer 10 and then, optionally upload the new information to the Internet server 40 by the Internet 30. A new CD 50 can be quickly issued to the patient, or if the CD 50 is a re-writable CD, the patient him- or herself can re-write the CD 50 with the updated medical file. Also, the present method may further comprise the step of inducing the patient to provide other personal information or documents such as payment authorization information, health insurance provider information, a living will, investment portfolios, life insurance and credit arrangements, etc., and then storing them in the Internet Server 40 and/or on the CD 50.

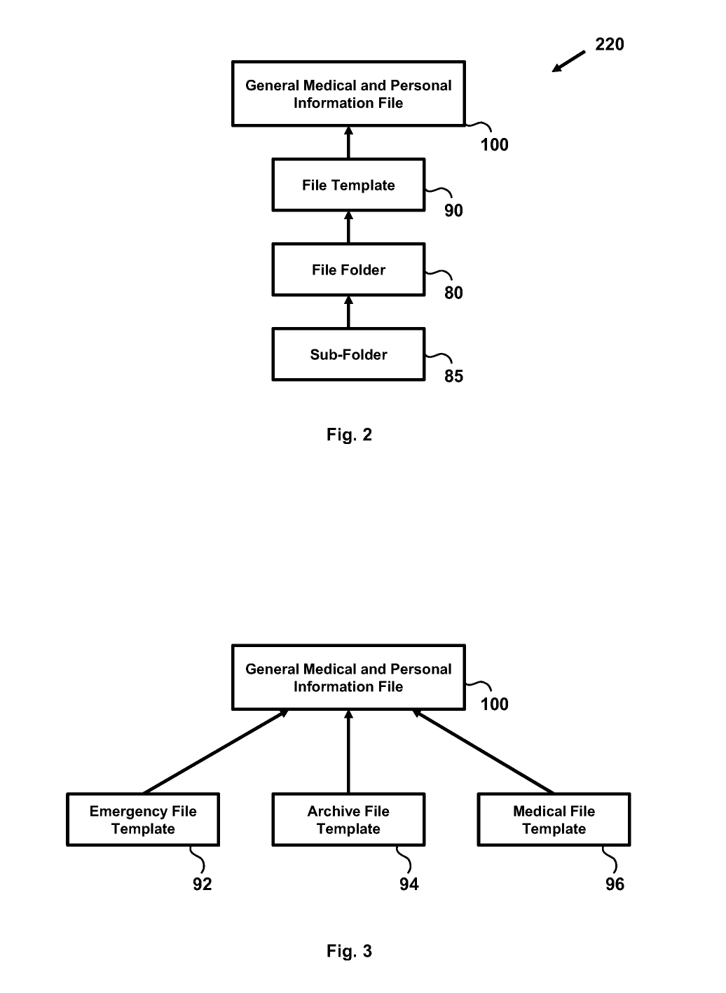

In an embodiment, the present method stores the medical record in a hierarchical storage system that can provide hierarchical access. Referring to FIG. 2, in accordance with an embodiment of the present invention, a medical record (not shown) may be assigned to at least one file folder 80, and all medical records assigned to a file folder can share one or more common attributes. For example, all medical records from a certain physician can be assigned to a file folder, all medical records from a certain hospital can be assigned to another file folder, all medical records relating to various tests and lab results can be assigned to a third file folder, all medical records relating to a specific physical condition or disease can be assigned to a fourth file folder, all medical records relating to a particular organ, such as the liver, can be assigned to a fifth file folder, and so on. The file folder contents may overlap, as when some of the particular physician records in one file folder relate to the particular disease in another file folder. The file folder 80 may comprise a sub-folder 85. For example, the file folder for tests and lab results may include sub-folders for EKGs, MRIs, X-rays, etc. Then the file folder 80 is assigned to at least one file template 90. The file folders assigned to a file template such as 90 can share one or more common attributes. For example, all the file folders containing information that might be useful in an emergency can be assigned to an emergency file template, and all file folders that contain archival information such as a living will, investment portfolios, life insurance and credit arrangements can be assigned to the archive file template. In accordance with an embodiment of the invention, all file templates are stored together in the hierarchy to form a general medical and personal information file 100 of the patient.

In this hierarchical storage system, access to a special file template can optionally be allowed on different terms than access to the general medical and personal information file 100 or another file template. Referring to FIG. 3, an example of a special file template is the emergency file template 92. A special file template (or any template) can be read-only so it cannot be altered by the third party. In accordance with an embodiment of the present invention, the information file 100 further comprises an archive file template 94 and a medical file template 96 that contains more medical information of the patient (for example information relating to venereal diseases long in the past) and is fully functional so its contents can be changed or updated by a person who has access to it.

The hierarchical storage access can be illustrated by a simple example. With the log-on information (account number, user ID and password) printed on the CD 50 or a medical emergency card, an emergency attendant can log on and have access to the emergency file template which is read-only, but to log on and have access to the general medical and personal information file 100 or other file templates such as the archive file template or the medical file template, one needs to answer a secret question in addition to the log-on information. With the hierarchical storage system, in another embodiment, a special file template (such as the emergency file template 92 or archive file template 94) is stored in a separate CD 50, requiring different access information from the CD storing the general medical and personal information file 100.

An alternate embodiment of the present invention, referring to FIG. 1, is an medical and personal information system 200 for obtaining and storing a medical record of a patient from a covered entity in a form allowing quick disclosure of the medical record to a third party without restriction by HIPAA. Referring to FIG. 1, the information system 200 comprises a communication interface 210 which comprises, in accordance with an embodiment of the invention, the Internet server 40 (e.g. a computer), the website 48, and the data processor 42. The Internet server 40 acting through the communication interface 210 is programmed to induce the patient to obtain possession of a medical record of the patient from a covered entity 70. For example, this may be done by placing on the website 48 instructions that a subscribing patient should obtain his or her medical records directly from the covered entities possessing the records. This optionally can be facilitated by providing the subscribing patient with a form letter to be sent to a covered entity to obtain copies of medical records. The form letter can provide information to the sender and recipient respecting how the records should be requested, who must request the records, how the requester can verify that the request is genuine, and so forth.

The website 48 can also be programmed or interlinked to provide additional information that may help the patient to request relevant medical records. For example, the website can provide, or link to, a directory of physicians, hospitals, and other health care providers and their contact information, so the patient can find out how to contact pertinent providers. The website can also be programmed to direct an e-mail request for medical records directly to a medical care provider, and can be programmed to provide the e-mail address of the selected medical care provider automatically, or to alert the patient if a proposed e-mail to a medical care provider does not bear the correct e-mail address of the selected medical care provider.

If the medical record is obtained by the patient in a format different from the intended storage format, the present system can be programmed to induce the patient to convert the medical record to the intended storage format. In an embodiment of the invention, an intended storage format can be a format that meets ACEP standards.

In accordance with an embodiment of the present invention, the Internet server 40 acting through the communication interface 210 can be programmed to further obtain the agreement of the patient to allow transmission of the medical record to a health care provider under defined conditions. This agreement can be obtained before a defined condition arises. The agreement can be obtained by placing on the website 48 a proposed agreement defining the conditions under which third parties will be given access to the information, or certain categories of information, and soliciting a response by the patient, as by clicking on a field displayed by the website 48, indicating assent to the terms of agreement. The service provider can then set up the subscriber's account to carry out the terms of the agreement.

In an embodiment, more than one proposed agreement can be presented on the website, and the patient can be instructed to select which of the agreements the patient wants to use. The agreement can also be provided in modular form, as in a checklist, and the patient can be induced to indicate assent to particular terms the patient finds suitable.

The website can also contain a free text entry field, where the patient can be solicited to propose one or more additional terms of agreement, for consideration by the service provider. The service provider can then review the proposed terms, determine whether to accept them, and if accepting them can determine how to implement the custom terms. The service provider can also respond to proposed terms by providing an amended version of the proposed agreement for consideration by the patient as a possible term of agreement. One advantage of allowing the patient to propose customized terms is that if a significant number of subscribers want terms that the service provider did not originally contemplate, the service provider can discover what terms are desired, arrive at language that many subscribers find desirable, and add such terms to its proposed agreements.

Referring now to FIG. 1, in accordance with an embodiment of the invention, the information system 200 further comprises a data storage device 45. The data storage device 45, in accordance with an embodiment, comprises either or both of the storage medium 44 and the CD 50. The data processor 42 can be programmed to acquire a medical record in an storage format and then store it in the storage medium 44 in a form from which it can be reproduced in the storage format. Preferably, the medical record is also stored on the CD 50 and, as described above, basic information about the service provider (for example its name and website), the patient (for example his or her name and logon information), and instructions for use are optionally printed on an adhesive label or otherwise applied to the CD 50.

The Internet server 40 operating through the communication interface 210 of the information system 200 may further be programmed to induce the patient to update the medical record stored in the data storage device 45, and may further be programmed to induce the patient to provide other personal information or documents such as payment authorization information, health insurance provider information, a living will, investment portfolios, life insurance and credit arrangements to be stored in the data storage device 45.

Alternatively, in accordance with an embodiment of the present invention, the information system 200 is or comprises a home health file storage system, in which the communication interface 210 comprises the communicating devices and data processor of the computer 10 and the system software installed in it for the home health file storage system (not shown). The home health file storage system further comprises the data storage device of the computer 10, such as its hard drive, CD-burner, CD 50, etc. The computer 10 together with the system software installed in it are programmed to carry out all the functions of the Internet medical file storage system described above, i.e. the information system 200 comprising the Internet server 40, website 48, data processor 42 and data storage device 45. The home health file storage system may be either interactive with such an Internet medical file storage system or be independent.

In accordance with an embodiment of the invention, referring to FIG. 2, a hierarchical storage system 220 is used to store the medical record and other personal information or documents in the data storage device 45 (or the data storage device of the computer 10) of FIG. 1. The hierarchical storage system 220 comprises a general medical and personal information file 100 of the patient. This information file 100 comprises at least one file template 90 which comprises at least one file folder 80. The file folder 80 may comprise subfolders. The hierarchical storage system 220 provides hierarchical storage access, so access to a special file template is on a different basis than the one for entry to the general medical and personal information file 100 or other file templates.

For example, referring to FIG. 3, the information file 100 may include an emergency file template 92, an archive file template 94 and a medical file template 96. The emergency file template 92 is a special file template that is read-only to emergency medical personnel and contains medical information of the patient useful to emergency attendants. The emergency file template 96 can also contain payment authorization information, health insurance provider information, etc., so the emergency medical care personnel can be assured that the patient has the means to pay for the medical services required. The archive file template 94 can contains areas for providing information such as a living will, life insurance, etc., and the medical file template 96 can contain the complete medical file of the patient including payment authorization information, health insurance provider information, etc.

In this example, with the log-on information only, one can log on and have access to the emergency file template 901, while to log on and get access to the archive file template 94 and/or medical file template 96, one must answer a secret question in addition to provide the log-on information. In another embodiment of the invention, the emergency file template 92 is stored in a different CD 50 from the one storing the archive file template 94 and/or the medical file template 96. Access to the respective CD's can be independently controlled as by normally carrying the emergency CD with directions and access information printed on a label, and by normally having the archive CD at home, and by providing it with no legible password information so it cannot be read by others.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiments disclosed, but that the invention will include all embodiments falling within the scope of the appended claims.

1. A method for a service provider that is not the patient or a covered entity to obtain a medical record of a patient from a covered entity in a form allowing the service provider to quickly disclose the medical record to a third party without restriction by the Health Insurance Portability and Accountability Act of 1996, the method comprising:
A. the patient obtaining the medical record from a covered entity in a first format;
B. the patient converting the received medical record to a converted medical record in a storage format that is not a medical record from a covered entity, in which converting comprises summarizing, abstracting, retyping, redacting, supplementing, or organizing the medical record, without the service provider modifying the information or its format in the received or converted medical record, in which the storage format is different from the first format;
C. the service provider, which is not the patient or a covered entity, receiving the converted medical record from the patient in the storage format;
D. the service provider storing the converted medical record that is not a medical record from a covered entity in a memory in a form from which the converted medical record can be reproduced in the storage format;
E. the service provider undertaking to transmit the converted medical record to a third party in the storage format as received from the patient under defined conditions; and
F. the service provider transmitting the converted medical record to a third party in the storage format as received from the patient when the defined conditions occur.

2. The method of claim 1, in which the medical record is made by the covered entity before the patient obtains the medical record from a covered entity.

3. The method of claim 1, in which the service provider provides instructions to the patient indicating how to obtain the medical record before the patient obtains possession of the medical record.

4. The method of claim 1, in which the patient obtains possession of the medical record before the service provider receives it.

5. The method of claim 1, in which the patient has a computer with Internet access, and the patient obtains the medical record by downloading the medical record in digital form from a covered entity to the patient's computer.

6. The method of claim 1, further comprising the patient acquiring the medical record in a digital storage format without intervention of any entity or person other than the covered entity.

7. The method of claim 1, in which the memory is a portable medium.

8. The method of claim 7, in which the portable medium is an optical disc.

9. The method of claim 1, further comprising retrieving the medical record stored in the memory remotely through a computer communications network.

10. The method of claim 1, further comprising the patient updating the medical record stored in the memory.

11-12. (canceled)

13. The method of claim 1, in which the medical record in the storage format is stored in a hierarchical storage system.

14. The method of claim 11, in which the medical record in the storage format is assigned to at least one file folder, the file folder containing medical records sharing at least one common attribute.

15. The method of claim 14, in which the file folder is assigned to at least one file template, the file template containing file folders sharing at least one common attribute.

16. The method of claim 15, in which a plurality of the file templates are stored in the storage system to form a general medical and personal information file of the patient.

17. The method of claim 14, in which the file folder further comprises at least one sub-folder.

18. The method of claim 13, in which the hierarchical storage system provides hierarchical storage access.

19. The method of claim 16, in which access to a special file template is on a different basis than access to at least one other file template.

20. The method of claim 21, in which the special file template is an emergency file template.

21. A method for a patient to convert a medical record of the patient from a covered entity to a form allowing quick disclosure of the medical record to a third party without restriction by the Health Insurance Portability and Accountability Act of 1996, the method comprising:
A. the patient obtaining possession of the medical record from a covered entity;
B. the patient converting the medical record into a storage format in which converting comprises by summarizing, abstracting, retyping, redacting, supplementing, or organizing the medical record, without the service provider modifying the information or its format in the medical record, in which the storage format is different from the first format; and
C. the patient storing the converted medical record in a memory in the storage format, in which the memory is accessible to the service provider and the converted memory is not under restriction by the Health Insurance Portability and Accountability Act of 1996.

22-36. (canceled)

37. A medical and personal information system for obtaining and storing a medical record of a patient from a covered entity in a form allowing quick disclosure of the medical record to a third party without restriction by the Health Insurance Portability and Accountability Act of 1996, the system comprising:
A. a communication interface provided at least in part by a service provider that is not the patient or a covered entity, the interface being adapted to enable the patient to obtain possession of the medical record of the patient from a covered entity in a first format and to enable the patient to convert the obtained medical record from the first format to a converted medical record in a storage format that is different from the first format, in which converting comprises summarizing, abstracting, retyping, redacting, supplementing, or organizing the obtained medical record obtained from a covered entity, without the service provider modifying the information or its format in the converted medical record, in which the storage format; and
B. a data storage device provided at least in part by a service provider, the storage device comprising a memory adapted for storing the converted medical record in a form from which it can be reproduced in a storage format, in which the storage device is configured to, store the converted medical record in the storage format.

38-59. (canceled)
